(19) United States
(12) Patent Application Publication
(10) Pub. No.: US 2011/0109741 A1
(43) Pub. Date: May 12, 2011

(54) ELECTRONIC DEVICE AND MONITORING METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/768,546

(22) Filed: Apr. 27, 2010

(30) Foreign Application Priority Data
Nov. 12, 2009 (CN) 200910309609.6

(51) Int. Cl. H04N 7/18

(52) U.S. Cl. 348/143; 348/E07.085

(57) ABSTRACT

An electronic device includes a communication unit, a capturing unit, and a processing unit. The capturing unit is adapted to capture video images of a monitored area. The processing unit is adapted to transmit the captured video images to a predetermined network address via the communication unit.

### BACKGROUND

1. Technical Field

The present disclosure relates to electronic devices, and particularly to monitoring methods implemented by electronic devices.

2. Description of Related Art

For security, many people commonly install a camera in their home. The camera captures video images of a monitored area in the house, and then stores the captured video images in a memory. People do not commonly know the events happening in the house until they go home to access the video images stored in the memory.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the two views.

FIG. 1 is a block diagram of an electronic device in accordance with an exemplary embodiment.

FIG. 2 is a flowchart of a monitoring method in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

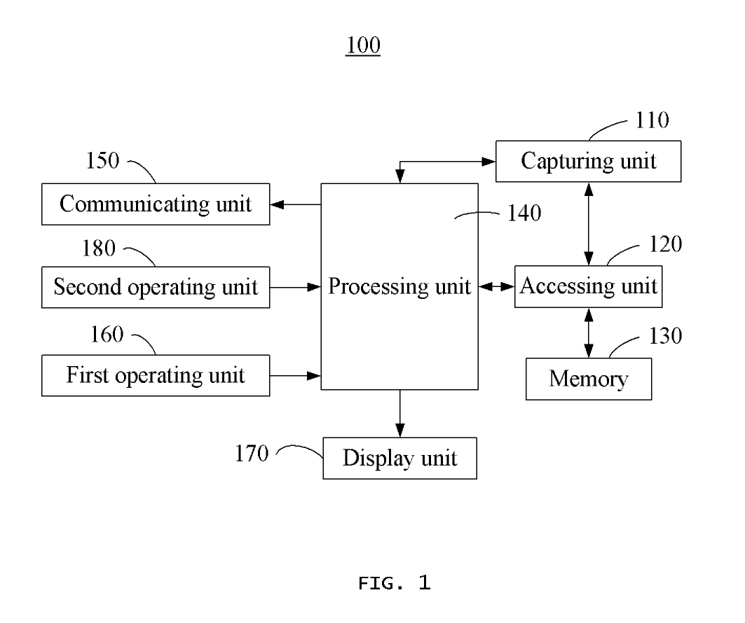

Referring to FIG. 1, an electronic device 100 includes a capturing unit 110, an accessing unit 120, a memory 130, a processing unit 140, a communicating unit 150, a first operating unit 160, a display unit 170, and a second operating unit 180. The electronic device 100 may be a television, a set-top box, or a computer.

The capturing unit 110 is used for capturing video images of a monitored area to monitor events happening in the monitored area. If the electronic device 100 is located in a house, events happening in the house will be monitored. In the embodiment, the capturing unit 110 may be a camera.

The accessing unit 120 is electrically connected between the capturing unit 110 and the memory 130. The accessing unit 120 is used for storing the captured video images in the memory 130 for a user to access later. In the embodiment, the memory 130 may be a hard disk.

The processing unit 140 is used for improving quality of the captured video images, and transmitting the improved video images to a predetermined network address via the communication unit 150. The predetermined network address may be but not limited to an Email address. The communication unit 150 may be constructed based on wireless or wire technology. When a user is not at home, the user can view the events happening in the house by accessing the improved video images through the predetermined network address at any time from any remote network.

In the embodiment, the processing unit 140 estimates motion of the captured video images first, and then compensating the motion of the captured video images according to the estimated motion, thus the quality of the captured video images are improved.

The first operating unit 160 is used for generating a reproduced signal in response to a user's operation. The first operating unit 160 may be a first key arranged on the electronic device 100. The reproduced signal is generated when the first key is pressed down.

The processing unit 140 is also used for controlling the accessing unit 120 to obtain the captured video images from the memory 130, improving quality of the captured video images, and transmitting the improved video images to the display unit 170 in response to the reproduced signal.

The display unit 170 is used for reproducing the improved video images, thus the user can view higher resolution video. In other embodiments, the display unit 170 may be replaced by a television, or a display capable of displaying the video images.

The second operating unit 180 is used for generating an operating signal in response to a user's operation. In the embodiment, the second operating unit 180 may be a second key arranged on the electronic device 100. The operating signal is generated when the second key is pressed down.

The processing unit 140 is also used for enabling the capturing unit 110 in response to the operating signal such that the capturing unit 110 is capable of capturing the video images of the monitored area. In addition, when a user is at home, the capturing unit 110 can be disabled, thus energy can be saved.

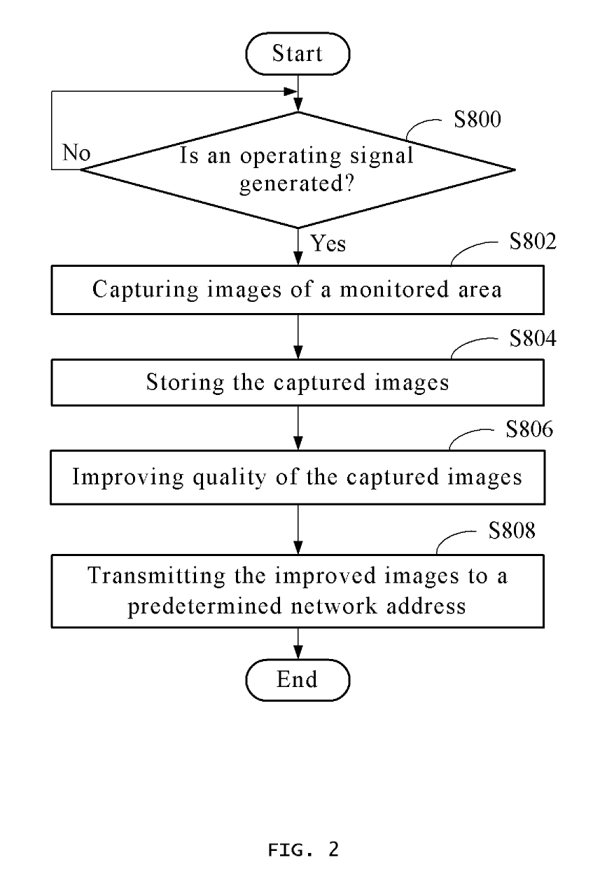

Referring to FIG. 2, a monitoring method is provided. The method may be applied in an electronic device capable of capturing video images. The method includes the following steps:

In step S800, determining whether an operating signal is generated. If the operating signal is determined to be generated, step S802 is implemented. If the operating signal is determined not to be generated, step S800 is repeated. In the embodiment, the electronic device has a first key. The operating signal is generated when the first key is pressed down.

In step S802, capturing video images of a monitored area to monitor events happening in the monitored area. In the embodiment, if the electronic device is located in a house, events happening in the house may be monitored.

In step S804, storing the captured video images to be accessed by a user later. In the embodiment, the electronic device has a memory for storing the captured video images. The memory may be a hard disk.

In step S806, improving quality of the captured video images by estimating motion of the captured video images first, and then compensating the motion of the captured video images according to the estimated motion.

In step S808, transmitting the improved video images to a predetermined network address. The predetermined network address may be but not limited to an Email address. When a user is not at home, the user can view the events happening in the house by accessing the improved video images through the predetermined network address at any time from any remote network.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising:
a communication unit;
a capturing unit adapted to capture video images of a monitored area; and
a processing unit adapted to transmit the captured video images to a predetermined network address via the communication unit.

2. The electronic device according to claim 1, wherein the predetermined network address is an Email address.

3. The electronic device according to claim 1, wherein the processing unit further improves quality of the captured images.

4. The electronic device according to claim 3, wherein the processing unit improves the quality of the captured video images by estimating motion of the captured video images, and compensating the motion of the captured video images according to the estimated motion.

5. The electronic device according to claim 1, further comprising:
a memory; and
an accessing unit adapted to store the captured video images in the memory.

6. The electronic device according to claim 5, further comprising:
a display unit;
a first operating unit adapted to generate a reproduced signal in response to a user's operation; and
wherein the processing unit further controls the accessing unit to obtain the captured video images from the memory, and transmits the captured video images to the display unit in response to the reproduced signal such that the captured video images are reproduced by the display unit.

7. The electronic device according to claim 1, further comprising:
a second operating unit adapted to generate an operating signal in response to a user's operation;
wherein the processing unit further enables the capturing unit in response to the operating signal such that the capturing unit is capable of capturing the video images of the monitored area.

8. A monitoring method implemented by an electronic device, the electronic device comprising a capturing unit, the monitoring method comprising:
capturing video images of a monitored area; and
transmitting the captured video images to a predetermined network address.

9. The method according to claim 8, further comprising:
improving quality of the captured video images before the step of transmitting the captured video images to the predetermined network address.

10. The method according to claim 8, wherein the predetermined network address is an Email address.

11. The method according to claim 8, further comprising:
determining whether an operating signal is generated; and
if the operating signal is determined to be generated, the step of capturing the video images of the monitored area is implemented.

12. The method according to claim 11, further comprising:
if the operating signal is determined not to be generated, repeating the step of determining whether the operating signal is generated.

13. The method according to claim 8, wherein the quality of the captured video images are improved by estimating motion of the captured video images, and compensating the motion of the captured video images according to the estimated motion.
